(19) United States
(12) Patent Application Publication
(10) Pub. No.: US 2004/0178130 A1
(43) Pub. Date: Sep. 16, 2004

(54) Filter for use in a flowing viscous medium

(76) Inventors: Udo Diehl, Stuttgart (DE); Simon Kieser, Sachsenheim (DE)

Correspondence Address: KENYON & KENYON, ONE BROADWAY, NEW YORK, NY, 10004, US

(21) Appl. No.: 10/483,579

(22) PCT Filed: Nov. 14, 2002
(86) PCT No.: PCT/DE02/04202

(30) Foreign Application Priority Data
May 15, 2002 (DE) 102 21 566.9

(51) Int. Cl. B01D 35/18

(52) U.S. Cl. 210/184

(57) ABSTRACT

A filter is indicated for use in a flowing, viscous medium, particularly in the delivery flow of a pump delivering hydraulic oil for an electrohydraulic valve control, that has a filter housing (11) including an inlet and outlet (12, 13), and a filter element (15) arranged in the filter housing (11) between the inlet and outlet (12, 13). To maintain good filtering action and reduce the flow resistance in the filter at low temperatures, the filter element (15) is provided with an electrical heating device (18)

### BACKGROUND INFORMATION

The present invention is based on a filter for use in a flowing, viscous medium, particularly in the delivery flow of a pump delivering hydraulic oil for an electrohydraulic valve control, according to the preamble of Claim 1.

For an electrohydraulic valve control, as is described, for example, in DE 198 26 047 A1, the hydraulic oil, under high pressure, for triggering the hydraulic actuators actuating the gas-exchange valves in the combustion cylinders of the internal combustion engine is made available by a high-pressure pump that is supplied with hydraulic oil from a hydraulic-oil reservoir either directly by drawing in or indirectly via a presupply pump. As a rule, a hydraulic-oil filter is disposed on the intake side of the high-pressure pump to eliminate dirt particles contained in the hydraulic oil.

### SUMMARY OF THE INVENTION

The filter of the present invention having the features of Claim 1 has the advantage that the viscous medium, particularly the hydraulic oil, flowing through the filter element of the filter is heated by the electrical heating device, and thus the viscosity of the medium, increasing at low temperatures, is perceptibly reduced. In this manner, the flow resistance of the filter is decreased, and pressure losses in the delivery flow are avoided. The filter function is retained, even at low temperatures. On one hand, the integration of the heating device into the filter saves on additional mounting space for the heating in the medium flow, and on the other hand, due to the large surface of the filter element, ensures an intensive heat transfer, so that the heating device exhibits excellent efficiency

The measures specified in the further claims permit advantageous further developments and improvements of the filter indicated in Claim 1.

According to one preferred specific embodiment of the present invention, the filter housing has a cup shape and is divided by the filter element into a hollow-cylindrical, outer filter chamber and into a cylindrical, inner filter chamber. Disposed at each end face of the filter housing is a preferably ring-shaped electrode for applying an electric potential of a heating voltage, from which electroconductive current webs, set apart from each other, extend axially over the filter element. The heating device has a plurality of resistance wires that are arranged on the surface of the filter element and in each case are stretched between the current webs of the one electrode and the current webs of the other electrode. These measures permit a construction of the filter with heating device that is simple from the standpoint of design and production engineering, and which ensures excellent heat transfer from the heating device to the medium flowing through the filter element.

### BRIEF DESCRIPTION OF THE DRAWINGS

The invention is explained in detail in the following description in light of an exemplary embodiment shown in the Drawing, in which:

FIG. 1 shows a perspective representation of a filter for an electrohydraulic valve control;

FIG. 2 in a cutaway view, shows a plan view in the direction of arrow II in FIG. 2 of a developed view of a heating device integrated in the filter;

FIG. 3 in a cutaway view, shows a section of the filter along the line III-III in FIG. 2.

### DESCRIPTION OF THE EXEMPLARY EMBODIMENT

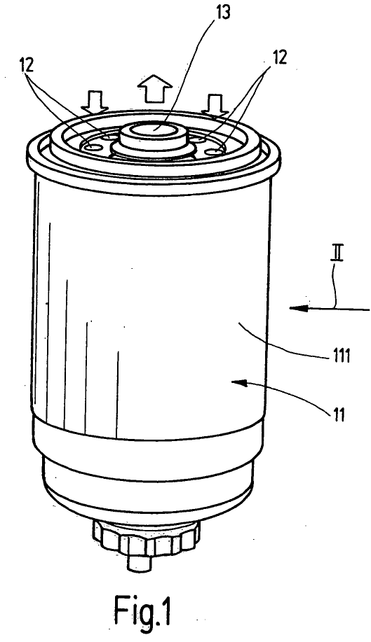

The filter shown in FIG. 1 is used in an electrohydraulic valve control of gas-exchange valves in internal combustion engines, as is described, for example, in DE 198 26 047 A1. For the pressure supply of the hydraulic actuators actuating the gas-exchange valves, hydraulic oil is raised to high pressure by a high-pressure pump. The hydraulic oil is drawn in from a hydraulic-oil reservoir. Often arranged upstream from the high-pressure pump is a presupply pump which delivers the hydraulic oil from the hydraulic-oil reservoir to the high-pressure pump. The filter shown in FIG. 1 is positioned on the intake side of the high-pressure pump, thus between the presupply pump and the high-pressure pump.

The filter has a cup-shaped filter housing 11 including an inlet 12 and an outlet 13, indicated in FIG. 1 by flow arrows. As the sectional view according to FIG. 3 shows in a cutaway portion, the casing of filter housing 11 is double-walled, and the ring-shaped hollow space between the two housing walls 111 and 112 is filled with a heat-insulating material 14. Inside filter housing 11, a filter element 15 is arranged concentrically, which separates inlet 12 from outlet 13. Filter element 15 is made of a flat, strip-shaped filter material which is inserted, in star-pleated fashion in the shape of a circle, in filter housing 11, and divides filter housing 11 into a hollow-cylindrical outer filter chamber 16 and a cylindrical inner filter chamber 17. In the exemplary embodiment of the filter shown, outer filter chamber 16 is connected to inlet 12 on filter housing 11, and inner filter chamber 17 is connected to outlet 13 on filter housing 11.

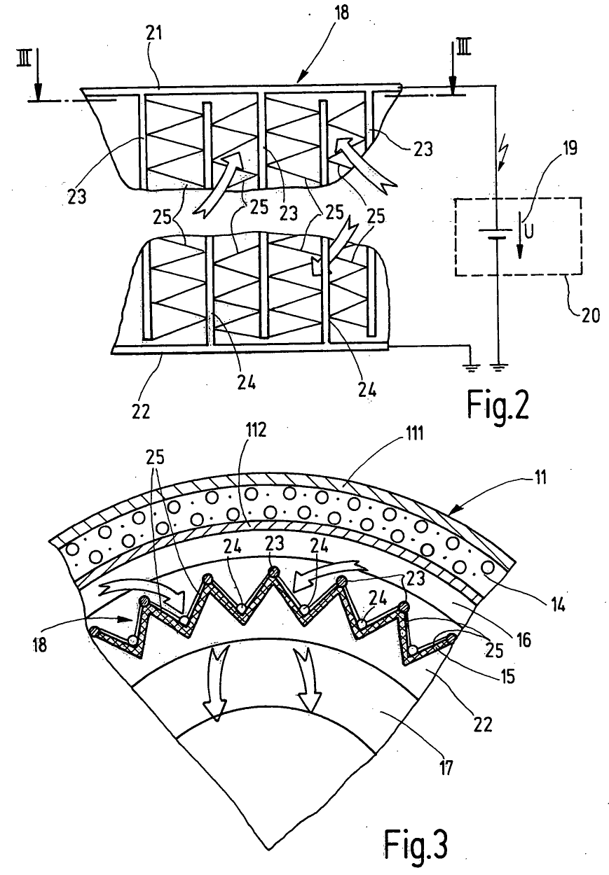

Filter element 15 is provided with an electrical heating device 18, to which a heating voltage 19, here a direct voltage, is applied, which, for example, is picked off in a control unit 20 for the electrohydraulic valve control. Electrical heating device 18 includes a plurality of resistance wires 25 which are distributed over filter element 15 and are arranged on the surface of filter element 15, and specifically on the side of filter element 15 facing outer filter chamber 16. As can be seen in the developed view of electrical heating device 18 according to FIG. 2, heating device 18 has an upper electrode 21, which is connected to the plus potential of heating voltage 19, and a lower electrode 22 which is connected to the minus or frame potential of heating voltage 19. Electroconductive current webs 23, that are set apart from each other, extend from upper electrode 21 axially over filter element 15, and identical current webs 24, again set apart from each other in the circumferential direction, extend from lower electrode 22 likewise axially over filter element 15.

Parallel-running current webs 23, 24 are arranged so that, viewed in the circumferential direction, they are approximately equidistant from each other. As can be seen in FIG. 3 for lower electrode 22, the two electrodes 21, 22 are implemented as electroconductive annular surfaces disposed at the end faces of filter housing 11. In the exemplary embodiment shown, current webs 23, 24, bracing therefrom at right angles, are formed as bars having a circular cross-section, but may also have a flat cross-section. The two electrodes 21, 22, with their integral current webs 23, 24, are preferably produced as a pressed screen. Between current webs 23, 24 of upper and lower electrodes 21, 22, in each case a resistance wire 25 is stretched which, as shown in FIG. 2, runs in zigzag fashion between the two current webs 23, 24. The tips or apexes of resistance wire 25 are electrically contacted on one side to current web 23, and on the other side to current web 24.

Alternatively, it is possible to give resistance wires 25 a meander-shaped profile between current webs 23, 24, the apexes of the meander-type arches again being electroconductively affixed to current webs 23, 24.

At low temperatures (e.g. −30° C.), the hydraulic oil is very thick-flowing, thus has great viscosity. When starting the internal combustion engine, in a preliminary phase, electrical heating device 18 in the filter is switched on together with the high-pressure pump. The current flows from upper electrode 21 via resistance wires 25 and via lower electrode 22. The cold volumetric flow of hydraulic oil taken from the hydraulic oil reservoir is heated by resistance wires 25 and filtered by filter element 15 situated behind them, so that after a suitable heating time, the filtered and heated volumetric flow may be fed, without pressure loss due to increased filter resistance, to the high-pressure pump. Heat-insulating material 14 in the double-walled casing of filter housing 11 improves the heat output of electrical heating device 18.

The described filter is not restricted to use for an electrohydraulic valve control. Thus, it may be used anywhere it is necessary to filter viscous media (liquids or gases) which have a viscosity dependent on the operating temperature. An example for another application is its use as a fuel filter for diesel fuel-injection systems.

What is claimed is:

1. A filter for use in a flowing, viscous medium, particularly in the delivery flow of a pump delivering hydraulic oil for an electrohydraulic valve control, comprising a filter housing (11), having an inlet and outlet (12, 13), and a filter element (15) arranged in the filter housing (11) between the inlet and outlet (12, 13),
wherein the filter element (15) is provided with an electrical heating device (18).

2. The filter as recited in claim 1,
wherein the electrical heating device (18) has a plurality of resistance wires (25) distributed over the filter element (15).

3. The filter as recited in claim 2,
wherein the resistance wires (25) are arranged on the surface of the filter element (15).

4. The filter as recited in claim 3,
wherein the resistance wires (25) are arranged on the side of the filter element (15) facing the inlet (12).

5. The filter as recited in one of claims 2 through 4,
wherein the filter housing (11) has a cup shape and is divided by the filter element (15) into a hollow-cylindrical outer filter chamber (16) and a cylindrical inner filter chamber (17); at each end face of the filter housing (11), an electrode (21, 22) is disposed for applying an electric potential of a heating voltage, from which electroconductive current webs (23, 24), which are set apart from each other, extend axially over the filter element (15); and the resistance wires (25) in each case are stretched between the current webs (23) of the one electrode (21) and the current webs (24) of the other electrode (22).

6. The filter as recited in claim 5,
wherein the electrodes (21, 22) are ring-shaped, and the current webs (23, 24) are bar-shaped having a round or flat cross-section.

7. The filter as recited in claim 5 or 6,
wherein a resistance wire (25) runs in a meandering or zigzag fashion between in each case a current web (23) of the one electrode (21) and a current web (24) of the other electrode (22); and in the apexes of its meander-shaped or zigzag profile, the resistance wire (25) is affixed in an electroconductive manner to the current webs (23, 24).

8. The filter as recited in one of claims 5 through 7,
wherein the filter element (15) is made of a flat, strip-like filter material, and is inserted, in star-pleated fashion in the shape of a circle, in the filter housing (11).

9. The filter as recited in claim 7 or 8,
wherein the current webs (23) of the one electrode (21) run along the star tips, and the current webs (24) of the other electrode (22) run in the star base of the filter element (15).

10. The filter as recited in one of claims 5 through 9,
wherein the outer filter chamber (16) is enclosed by a covering made of heat-insulating material (14).
